(19) United States
(12) Patent Application Publication
(10) Pub. No.: US 2006/0178183 A1
(43) Pub. Date: Aug. 10, 2006

(54) Poker game

(76) Inventor: Shawn Michael Van Asdale, Reno, NV (US)

Correspondence Address: Lena T. Van Asdale, 2573 Rampart Terrace, Reno, NV, 89509, US

(21) Appl. No.: 11/053,276

(22) Filed: Feb. 8, 2005

(51) Int. Cl. A63F 13/00

(52) U.S. Cl. 463/13

(57) ABSTRACT

The method of the present invention involves a game, preferably a poker game, in which a player preferably selects the number of opponents he will face. This decision is preferably made after the player is aware of his starting poker hand and has previously made a starting wager. Preferably the player must beat each opponent to receive a win amount and the average size of the win amount increases as the number of opponents faced increases. In one preferred embodiment, this is accomplished by comparing the player's final hand and/or the final hands of one or more opponents to a pay table, where the pay table assigns a value to each ranking of poker hand and the values for hands generally increase as the number of opponents faced increases.

### BACKGROUND OF THE INVENTION

The present invention is an improved game primarily relating to poker and more particularly to video poker games. In standard video poker games the player is dealt a starting hand and is allowed to discard unwanted cards to create an intermediate drawing hand. Replacement cards are then added to the drawing hand in an effort to improve the hand's rank. The resulting hand is compared to a pay table of poker hand rankings where each poker hand has a defined payout. Other video poker games such as Pick 'Em Poker and Hold 'Em Challenge allow the player to select a drawing hand from two or more possible drawing hands with the object being to select the hand that will ultimately improve to the most valuable hand after the draw. Thus, in all forms of known video poker the player is essentially deciding what drawing hand he would prefer over other possible alternatives. The present invention offers players a new, additional and exciting decision to make other than what hand to draw to. In the present invention, players may select the number of opponents they wish to face. In order to receive a payout it may be required that the player beat each of the opponents. Thus, as the number of opponents increases, the likelihood of winning naturally decreases. In order to offset this, the average payouts made to a winning player increase in value with the number of opponents faced.

### SUMMARY OF THE INVENTION

The present invention involves a poker game where the player selects a number of opponents to play against. The player may select any number of opponents between a predetermined minimum and maximum number of potential opponents or, alternatively, the player may be given limited choices regarding the number of opponents to play against. The player's selection of the number of opponents may be made at various different points in the game, but is preferably made after the player has placed his wager and been apprised of the type of drawing hand he has. In one embodiment, the player is allowed to select opponents sequentially and after at least one opponent is selected, that opponent's hand is revealed and the player can choose to begin the draw or add additional opponents. Thus, the player may be provided additional information upon which to base his decision.

The actual hands held by the selected opponents may be established randomly or according to a logical routine. This routine may result in the potential opponents with the best hands being selected prior to potential opponents with lesser hands. The player may or may not have a role in establishing which opponents are selected, and therefore which hands are selected in conjunction with a computer. Once the selected opponents and their hands have been established, the computer may make any necessary strategic decisions regarding the opponents' hands (e.g., what cards to hold, if the player is playing a game where cards can be discarded) and the poker draw is completed such that each opponent and the player has a final poker hand. The player's hand may then be compared to the remaining opponents' hands to determine the superior hand. Preferably the player will receive a payout if he has the best hand.

On average, the amount a player will receive for a winning hand will increase as the number of opponents increases. This increase in average payout amount per win may be accomplished in a variety of ways. These ways include, but are not limited to (1) providing the player with multiple pay tables based on the number of opponents where greater opponents generally result in larger payouts for a given hand, (2) making an award to the player based, at least in part, on the value of the opponents' hands that were beaten and (3) multiplying all or a portion of a standard pay table by a number that is a function of the number of opponents.

### DESCRIPTION OF THE PRIOR ART

Electronic gaming machines, also generally referred to as slot machines, have long been a mainstay of the gaming industry. One of the most popular types of such machines is by far the game of video poker. It is believed that video poker appeals to a number of players because it is more intellectually stimulating than other slot machines that merely present the player with a random display of symbols using physical or video reels or the like. This is because with video poker a player is given the opportunity to make strategic decisions based upon mathematical principles in the form of selecting which cards to be held that affect the outcome of each game. It is believed that this provides the player with a sense of control that is both entertaining and reassuring. Also, a player well versed in the strategy of a particular video poker game will, over the long run, fair better than a player who does not fully understand the strategy involved for a particular video poker game.

Another reason that video poker is popular among players is because these machines typically will have a much better payback percentage than the reel-type slot machine. For instance reel-type slot machines typically have a payback percentage (or expected value) of between 80% and 90%. However, video poker games are often made available to players with theoretical payback percentages of 99%. In fact, gaming establishments frequently provide video poker games that have theoretical payback percentages greater than 100%. The reason gaming establishments can profitably offer such games, and the reason the payback percentage is “theoretical,” is because it is based upon a theoretical player who uses perfect strategy with every play of every hand. In reality, very few players can play perfectly all of the time.

Unlike a reel-type slot machine, the payback percentage for any game of video poker can be determined by looking at the game's pay table. The pay table will also dictate what the best strategy is for any given hand. Typically, as the payback percentages get closer to, or even exceed 100%, the complexity of the pay table increases as does the difficulty of determining what the best strategy is for a given hand. As a result, players and gaming establishments alike are constantly looking for new and exciting pay tables and game variations that offer the player the opportunity to play a high-return game but also consistently provide strong earnings to the gaming establishment.

The pay table also determines the volatility of the game. In a very volatile game like Double Double Bonus Poker, a player is more likely to have long streaks of minimal wins and losses with the occasional streak of huge wins. Whereas in a low volatility game like Jacks or Better, the losing streaks will typically not cost the player as much and the winning streaks will not reward the player as much. Although both Double Double Bonus Poker and Jacks or Better Poker may be offered at the same theoretical payback percentage, the volatility will differ greatly. Therefore, some players will prefer Double Double Bonus while others prefer Jacks or Better. And because the pay table determines the strategy, the theoretical payback and the volatility of the game, players have not been allowed to make any adjustments to the pay table to accommodate their specific desires.

It is therefore an object of the present invention to provide a new type of poker game that offers players a new and stimulating type of strategic decision other than what hand to draw to. This decision will include how many opponents to play against. It is a further object of the invention to provide a new type of poker game that allows for new and exciting pay table combinations and possibilities.

### BRIEF DESCRIPTION OF THE DRAWINGS

FIG. 1 shows an electronic gaming machine for playing a game according to the method of the present invention.

FIG. 2 is a schematic diagram of the electronic configuration of an embodiment of the gaming terminal shown in FIG. 1.

FIG. 3 is a flow chart showing the steps according to one version of the present invention.

FIG. 4 shows a screen display for one version of the present invention after the initial deal of the cards.

FIG. 5 shows a screen display that would follow FIG. 4 for one version of the present invention after the player has selected the number of opponents to be faced and each hand has been completed.

FIG. 6 shows a screen display for an alternative version of the present invention where the payout is determined by the value of the player's and opponents' hands.

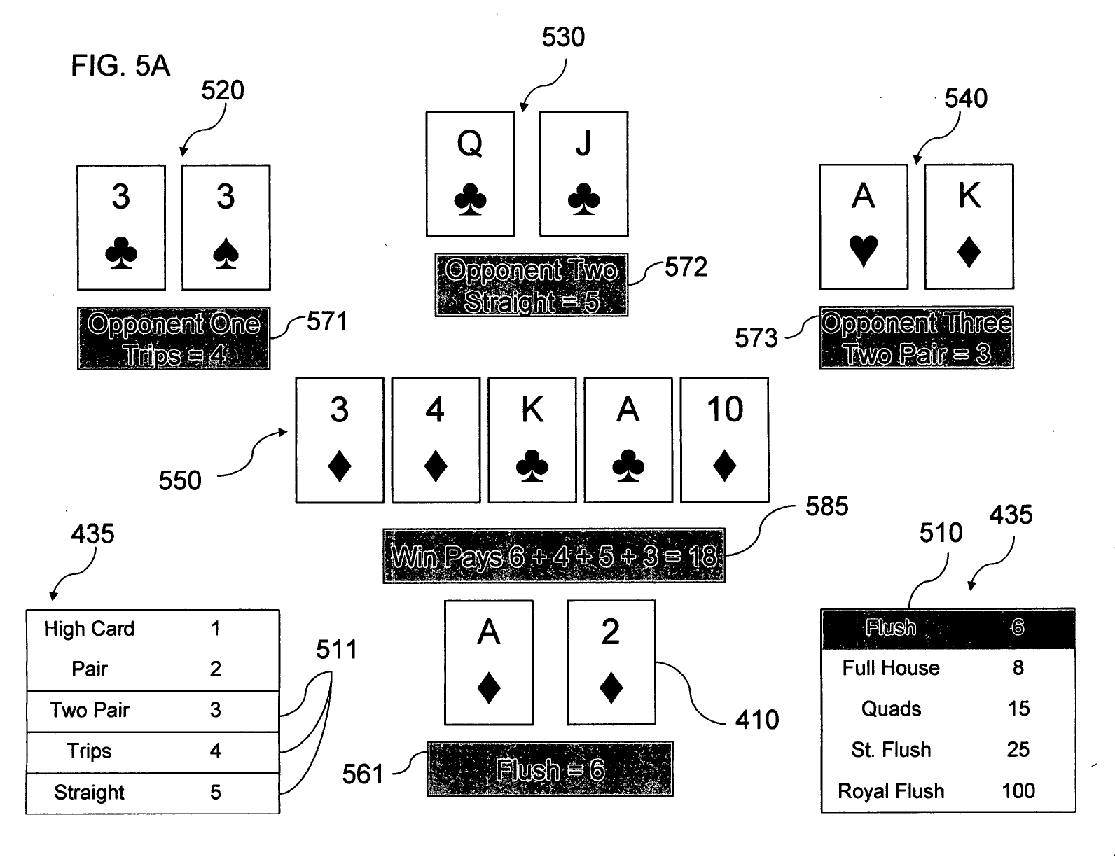

### DETAILED DESCRIPTION OF THE PREFERRED EMBODIMENTS

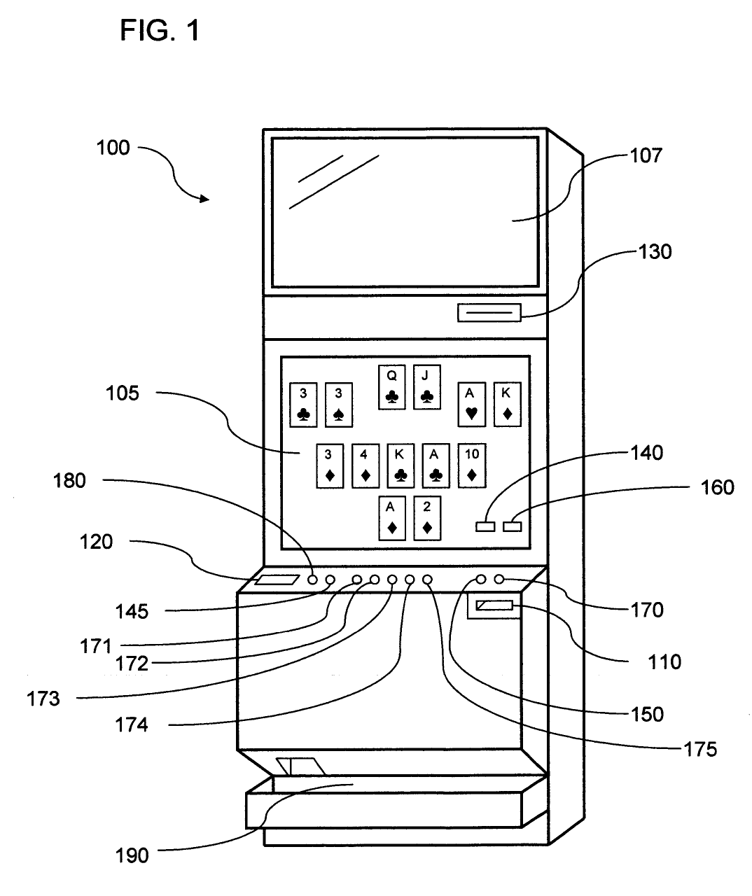

One embodiment of the present invention may be deployed on a gaming device 100 as illustrated in FIG. 1. Gaming device 100 has the features of a conventional slot machine. The gaming device 100 shown in FIG. 1 is what is commonly referred to as an upright slot machine and the player can operate it while standing or sitting. Most often the gaming device 100 is preferably mounted on a stand. (Not shown.) Although an up-right slot machine 100 is shown in FIG. 1, it can be appreciated that the gaming device 100 can be any other style of gaming machine known in the art including, but not limited to a pub-style table-top or slant-top game which a player can operate while sitting. The gaming device 100 can be constructed with varying cabinet and display designs.

Gaming device 100 can incorporate any primary game including, but not limited to reel slots, video poker, blackjack, keno or bingo. Further, there can be many types of bonus games associated with these primary games. The symbols and indicia used on and in gaming device 100 may be in mechanical, electrical, electronic or video form. Gaming device 100 shown in FIG. 1 has a video display 105 for displaying symbols.

It should be appreciated that the display devices may display any visual representation or exhibition, including but not limited to video images or movement of physical objects. The display devices can be a video monitor or screen, a liquid crystal display or any other display mechanism. Furthermore, it should be appreciated that these display devices may preferably include touch screens.

As shown in FIG. 1, gaming device 100 preferably includes one or more wager accepting mechanisms. The primary wager accepting mechanism on the gaming device 100 shown in FIG. 1 may be a bill validator 110. The bill validator 110 may also accept other forms of payment including, but not limited to tickets, smart cards, debit cards and credit cards. Alternatively, some of these forms of payment may be accepted through a card reader 130. The card reader 130 may include any type of card reading device, such as a magnetic card reader or an optical card reader. The player will insert a card, such as a player tracking card or a credit card into the card reader 130 which will then read data from the card. The card reader 130 may be used to read and/or write from and/or to the inserted card. There may also be a coin slot 120 on the gaming device 100 in which a player can insert coins or tokens.

After a player inserts money in the gaming device 100, either via the coin slot 120, the bill validator 110 or the card reader 130, a number of credits corresponding to the amount deposited is shown in a credit display 140. After money is credited to the machine 100 and shown on the credit display 140, the player then determines the wager amount. The machine 100 may have any number of mechanisms known in the art for allowing a player to determine his wager. As the player is selecting the wager amount, this wager amount is displayed on a bet display 160. As the bet display 160 amount is incrementing, the credit meter 140 amount is decreasing by the corresponding amount.

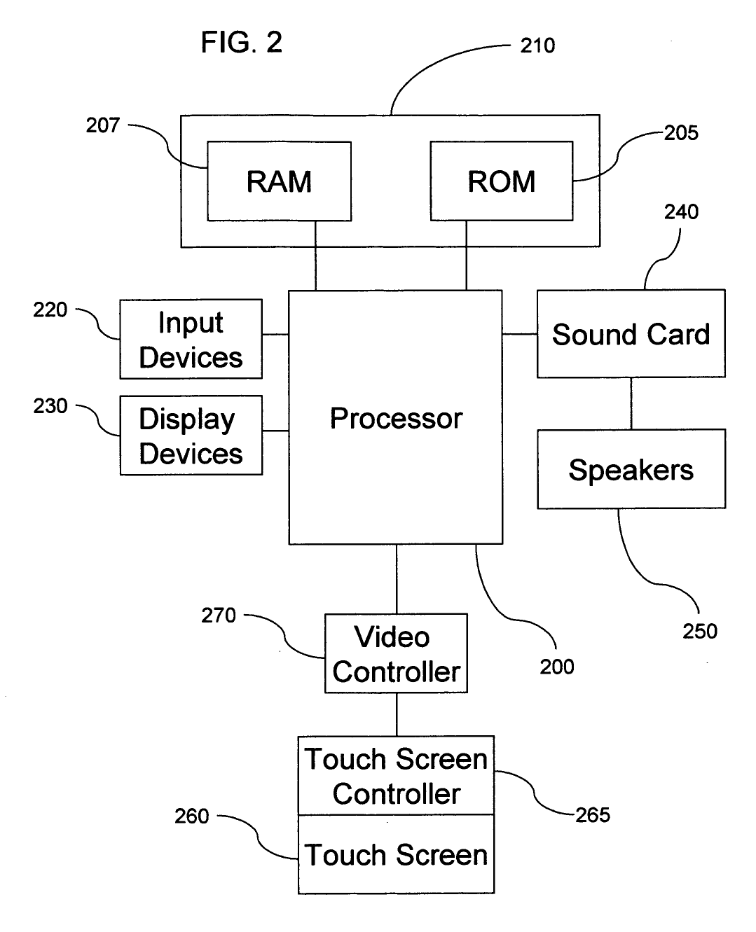

FIG. 2 is a block diagram of the general electronic configuration that may be incorporated in gaming device 100. The configuration preferably includes a processor 200. The processor 200 is preferably a microcontroller-based platform or microprocessor which is capable of displaying images, symbols and other indicia such as images of people, characters, places, things and faces of cards. One or more secondary processors may also be employed in conjunction with the primary processor to control certain aspects of the game function.

The gaming device 100 also includes a memory device 210 for storing program code or other data. This memory device 210 can include both read only memory (ROM) 205 and random access memory (RAM) 207. One of the functions performed by a program or sub-program in the processor 200 may be a random number generator (RNG) using any of several methods known to those skilled in the art. In addition to the memory device 210, the electronic configuration of the gaming device 100 may also include one or more input devices 220, one or more display devices 230, a sound card 240, and one or more speakers 250.

The input devices 220 may include but are not limited to a deal/draw button 145, a bet one credit button 170, a max bet button 150 and a cash out button 180. Initiating cash out button 180 may result in the player's balance from the credit meter 140 being deposited into a tray 190 in the form of coin, cash, a ticket or any other suitable media. Additional opponent selection buttons 171, 172, 173, 174 and 175 may be provided for selecting a number of opponents that a player will face. In situations where a touch screen 260 is used, a touch screen controller 265 and touch screen 260 are connected to a video controller 270 and the processor 200.

Although FIG. 2 shows the processor 200 and memory device 210 residing on the gaming device 100, it should be appreciated that it is possible for both the processor 200 and memory device 210 to reside at a central location instead of at the gaming device 100. In such a situation, a network server may be used to communicate to the gaming device over an Internet connection, local area network (LAN), or wide area network (WAN). The processor 200 and memory device 210 are generally referred to herein as the controller.

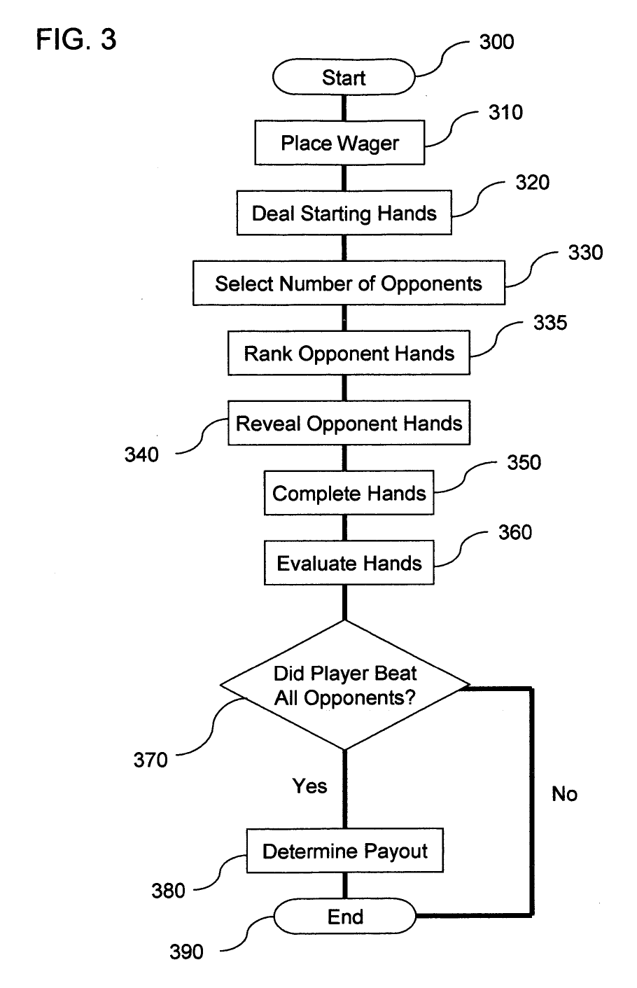

Referring now to FIG. 3, the general logic of a game according to the present invention will now be described. For the purposes of illustration, the specific type of poker game that is being played in this example is Hold 'Em. However, it should be understood that the present invention may be applied to any poker game. At step 310 the player places his wager for the game. At step 320 the processor 200 randomly deals a starting hand to the player and each potential opponent from a single virtual fifty-two card deck of playing cards. In the present example, each starting hand consists of two cards and the number of potential opponents is ten. At step 330 the player selects the number of opponents to face. In this example, this selection may be any number from one to five. At step 335 the processor 200 ranks the opponents' starting hands. In the present example each hand will be ranked from one to ten according to a predefined ranking of starting hands where one is the best of the ten starting hands and ten is the worst, statistically. At step 340 the processor reveals the hands of the opponents. In this example the first to nth opponent hands will be revealed, according to their previously ranked order, where n is the number of opponents selected. At step 350 the processor 200 completes the poker hands for the player and each opponent. In the present example, this requires the processor 200 to deal five community cards that the player and each opponent uses to make the best five card poker hand. At step 360 the processor 200 evaluates the final poker hand of each opponent and the player. At step 370 the processor 200 determines if the player beat each active opponent. If the player has not, the game proceeds to the end at step 390. If the player has beat each active opponent, the processor 200 calculates the payout to the winning player at step 380 and increments the credit meter 140, accordingly.

Although there are many variations of the present invention that are possible, each variation can generally be defined by describing four main aspects of the game. The first aspect is which type of poker game is being played, e.g., Five-Card Draw, Hold 'Em, Seven-Card Stud, Omaha, Five-Card Stud etc. In the game of Five-Card Draw the initial starting hand is five cards and the player is allowed to exchange any of his cards for additional cards to form a five card hand. In the game of Hold 'Em the initial starting hand is two cards and each player forms a five card hand using either none, one or both of the two cards in his starting hand and five community cards. In Seven-Card Stud the initial starting hand is three cards, where one card is dealt face up for all to see and the player makes his best five card hand from the three cards in the initial hand and four more cards dealt to each player. In Omaha the initial starting hand is four cards and each player forms a five card hand using two of the four cards in his starting hand and three of the five community cards. In Five-Card Stud the initial starting hand is two cards, where one card is dealt face up for all to see and the player makes his best five card hand from the initial hand and three later-dealt cards. Other poker game variants well known in the art may also be used.

The second aspect is how, at step 330, the player selects his opponents. The third aspect is how each opponent's starting hand is determined. In the previous example, this occurred at step 335. And the fourth aspect is how the payout is determined at step 380. Each of these aspects will now be discussed in greater detail.

### Opponent Selection

Preferably there is a predetermined minimum and maximum number of potential opponents that a player may face prior to the initiation of the game. And preferably, these numbers remain constant from one game to the next. However, it would of course be within the scope of the present invention for these numbers to vary from one play to the next of the same game being played on a single gaming device 100. Regardless, at some point in the game, the player preferably makes a selection to influence the number of actual opponents he will face. Thus, in many of the games played the number of actual opponents will be less than the maximum number of potential opponents.

In one embodiment the player's options regarding how many opponents to face are only limited to a number between the minimum and maximum number of potential opponents. Thus, if the minimum number of opponents is one and the maximum number of opponents is five, the player may chose to face any number of opponents between one and five. This may be accomplished by the player using the opponent selection buttons 171, 172, 173, 174 and 175, the touch screen 260 or other suitable player input devices. In one variation however, the player's choices are limited by the processor 200. In such a variation, although the minimum and maximum number of opponents may remain fixed from game to game, one or more of the opponents within this range is ineligible. Thus, if the minimum is one and the maximum is again five, the player's options may be limited to selecting one, two, four or five opponents. But the option of playing against three opponents is not available. The processor 200 may be programmed such that these options occur randomly or according to an algorithm that is a function of the player's starting hand or any other number of factors.

In yet another variation of the present invention, the player chooses his opponents sequentially and after one or more opponents have been chosen, the starting poker hands held by those opponents are revealed to the player and he is given the option of adding additional opponents to the game. The variation would add another level of strategy to the game in that the player may be able to determine if he is statistically ahead of or behind the opponents chosen so far and whether it would be to the player's advantage to add additional opponents.

In the preferred embodiment of each of these variations the player will be able to select an exact number of opponents to face. However, in other embodiments it may be possible for the player to identify a desired target number of opponents, but the processor 200 may increase or decrease the desired number on either a random, pseudo-random or logical basis.

Although the foregoing examples have all involved a game where the minimum number of opponents to face is one, it should be appreciated that the game may be designed such that a player may chose to face zero opponents as an option. In this scenario, the player may be required to place an ante bet in order to play. If the player selects a number of opponents other than zero, the total bet may be increased proportionally to the ante (for instance doubled). But if the player chooses zero opponents, the ante is forfeited. Alternatively, if zero opponents are selected, any payouts provided by a pay table could be severely reduced because the player no longer has to beat an opponent to win.

Also, it should be understood that although the preferred embodiments discussed so far have only allowed the player to determine the number of opponents at one point in the game, it would be within the scope of the present invention to allow such determinations to be made at a plurality of times. For instance, in the game of Hold 'Em, the player may make an opponent selection before any of the community cards are dealt and may subsequently alter the number of opponents, preferably by reducing the number, after the initial three community cards are dealt and may further have the option to alter the number of opponents after the fourth and fifth community card is dealt. Each time that the number of opponents is reduced, it may be preferable for the average payout for a winning hand to be reduced as well.

### Hand Selection

The starting hand dealt to the player and the starting hands dealt to all potential opponents will preferably be determined in a completely random fashion using random number generators and virtual card shuffling techniques well known in the art. This is preferred in order to ensure the integrity and fairness of the game. However, when less than all of the potential opponents are chosen to play a hand, there are several variations that can be used to determine which specific opponents, and therefore which specific starting hands will play. In perhaps the simplest embodiment, each potential opponent is randomly dealt a starting hand and once the player chooses how many opponents to compete against, the specified number of opponents (and their associated starting hands) is randomly selected from the potential opponents without regard to the strength of each potential opponent's starting hand. The selection of which specific opponent will play may be made randomly either by the processor 200 or by the player selecting specific opponents without any knowledge as to what each potential opponent likely holds.

As an alternative to the random selection of starting hands for the player to compete against, the processor 200 may employ an algorithm or other similar logic operation so that from the total pool of starting hands held by the potential opponents, certain starting hands will be selected before others. For instance, in the poker game Hold 'Em each player is initially dealt two cards. Thus, there are one-hundred and sixty-nine possible starting hands (ignoring the cards specific suit, there are thirteen pairs, seventy-eight suited combinations and seventy-eight unsuited combinations, where a suited combination is two cards of the same suit). The game memory 210 may include a ranking of each one-hundred and sixty-nine starting hands (for instance with pocket Aces, the best possible starting hand, ranked first and Seven-Two offsuit, one of the least desirable starting hands, ranked last). Once each potential opponent has been randomly dealt a starting hand and a desired number of opponents have been selected, the processor may, in this example, select the specific opponents that have the highest (or alternatively the lowest) ranked hands. The ranking of starting hands may vary depending upon the number of opponents selected or even the player's starting hand. For instance, it will be readily appreciated by those familiar with poker, and in particular the game of Hold 'Em that if starting hands are ranked solely according to their winning percentage, the ranking of the one-hundred and sixty-nine starting hands will vary with the number of players in the game. Table 1 below shows the variance in starting hand ranks for the top twenty hands when there are two players versus when there are six players:

TABLE 1

| Rank | 2 Players | 6 Players |
|---|---|---|
| 1 | AA Pair | AA Pair |
| 2 | KK Pair | KK Pair |
| 3 | QQ Pair | QQ Pair |
| 4 | JJ Pair | JJ Pair |
| 5 | TT Pair | AK Suited |
| 6 | 99 Pair | AQ Suited |
| 7 | 88 Pair | TT Pair |
| 8 | AK Suited | KQ Suited |
| 9 | AQ Suited | AJ Suited |
| 10 | 77 Pair | AK Offsuit |
| 11 | AJ Suited | AT Suited |
| 12 | AK Offsuit | KJ Suited |
| 13 | AT Suited | QJ Suited |
| 14 | AQ Offsuit | KT Suited |
| 15 | AJ Offsuit | AQ Offsuit |
| 16 | KQ Suited | 99 Pair |
| 17 | A9 Suited | QT Suited |
| 18 | 66 Pair | JT Suited |
| 19 | A8 Suited | KQ Offsuit |
| 20 | AT Offsuit | AJ Offsuit |

Preferably, the precise method used to rank the hands will be communicated to the player so that the player can evaluate the optimum play strategy. It should also be understood that the total number of potential opponents that receive starting hands may be greater than the maximum number of active opponents that a player may be allowed to select to play against. For instance, in an embodiment of the invention based on Hold 'Em, the total number of potential opponents may be ten, yet the player may be limited to selecting between one and five active opponents. In which case, each of the ten potential opponents would receive a starting hand and if the player elects to play against five opponents, the five opponents with the highest ranked (or statistically best) starting hands would play. It should be appreciated that such a scheme would make it significantly more difficult for a player to win against five opponents out of a potential ten opponents versus winning against five opponents out of a potential five.

It may also be desirable to display to the player the hands dealt to opponents who were not selected to play. In this way, the gaming device 100 may convey information to the player about what would have happened had the player made a different selection.

### Payout Amount

Central to the present invention is the concept of increasing, on average, the gross payout amount that a player receives for a winning hand as the number of opponents increases. The exact method used to alter the payout amount will determine many of the key aspects of the game, including the payback percentages, the volatility and the optimal strategy that players will need to employ. As previously stated there are a number of different ways to vary the expected payout amount for a winning hand as a function of the number of opponents faced. One preferred embodiment employs a pay table that varies according to the number of opponents. One possible pay table that could be used for the game of Hold 'Em is shown below in Table 2:

TABLE 2
PAY TABLE #1

| | NUMBER OF OPPONENTS | | | | |
|---|---|---|---|---|---|
| WINNING HAND | 1 | 2 | 3 | 4 | 5 |
| HIGH CARD | 1 | 1 | 1 | 3 | 3 |
| PAIR | 1 | 2 | 2 | 3 | 3 |
| 2 PAIR | 1 | 2 | 3 | 3 | 5 |
| THREE OF KIND | 3 | 3 | 4 | 5 | 5 |
| STRAIGHT | 3 | 3 | 4 | 5 | 5 |
| FLUSH | 4 | 4 | 5 | 5 | 5 |
| FULL HOUSE | 6 | 7 | 8 | 9 | 9 |
| FOUR OF KIND | 12 | 12 | 14 | 18 | 18 |
| STRAIGHT FLUSH | 14 | 14 | 14 | 30 | 30 |
| ROYAL FLUSH | 20 | 25 | 30 | 45 | 60 |

When the foregoing pay table is used and the player may chose to play against any number of opponents between one and five on each play and the opponents' hands are chosen at random (rather than using a ranking system or other algorithm as previously discussed) the payback percentage for this game when played at a mathematically optimal level is approximately 99.3% if the player is also paid on all ties as if they were wins. It will be appreciated by those skilled in the art that this same pay table would yield a different payback percentage if one or more of the aspects of the game were changed. For instance, if an algorithm was used to ensure that the hands held by the opponents that were selected were the statistically better starting hands, the payback percentage would be reduced as it would become harder for the player to win. The same would be true if instead of being allowed to always select between one and five opponents, the player was randomly given a more limited choice of opponents to face (for instance, on one play the player may be allowed to chose one, two or four opponents). Each time that this subset of opponent selections did not include the optimal number of opponents to face, the player would lose a fraction of the total expected return.

Based on the foregoing pay table and the statistical frequencies of the various starting hands, the following table indicates the distribution of number of opponents a player will choose to face in order to achieve the optimal-play payback percentage.

TABLE 3

| | 1 | 2 | 3 | 4 | 5 |
|---|---|---|---|---|---|
| | Opponent | Opponents | Opponents | Opponents | Opponents |
| Frequency | 16% | 24% | 24% | 18% | 18% |

As seen in Table 3, the optimal number of opponents to face is relatively evenly distributed. Or put another way, no one choice for a number of opponents faced is so prevalent as to allow a player to chose that number of opponents every time without suffering a significant loss in expected value. It is believed that it is important to the invention to consistently present the player with varying choices and reward the player for making the correct choice to maintain a fun and exciting game for the player to enjoy.

Of course the number of pay tables that could be used are virtually infinite. And each pay table will result in optimal play strategies that are relatively unique to the pay table. This is true even when the overall payback percentages for two different pay tables are nearly identical. For instance, like the previous pay table shown in Table 2, the following pay table in Table 4 has an optimal-play payback percentage of 99.3%:

TABLE 4
PAY TABLE #2

| | NUMBER OF OPPONENTS | | | | |
|---|---|---|---|---|---|
| WINNING HAND | 1 | 2 | 3 | 4 | 5 |
| HIGH CARD | 0 | 1 | 1 | 2 | 2 |
| PAIR | 1 | 1 | 2 | 3 | 3 |
| 2 PAIR | 1 | 2 | 3 | 3 | 4 |
| THREE OF KIND | 2 | 3 | 3 | 4 | 5 |
| STRAIGHT | 4 | 4 | 4 | 5 | 5 |
| FLUSH | 4 | 5 | 5 | 6 | 6 |
| FULL HOUSE | 6 | 7 | 7 | 8 | 9 |
| FOUR OF KIND | 17 | 23 | 25 | 27 | 35 |
| STRAIGHT FLUSH | 30 | 50 | 50 | 50 | 70 |
| ROYAL FLUSH | 100 | 140 | 160 | 180 | 300 |

However, the optimal play for Pay Table #2 will vary from that of Pay Table #1 for a number of given hands. This is made clear by looking at the distribution of number of opponents a player will choose to face in order to achieve the optimal-play payback percentage, as shown below:

TABLE 5

| | 1 | 2 | 3 | 4 | 5 |
|---|---|---|---|---|---|
| | Opponent | Opponents | Opponents | Opponents | Opponents |
| Frequency | 21% | 20% | 21% | 20% | 19% |

Looking at a particular group of starting hands, for instance pairs, the differences in strategy that the two pay tables leads to becomes even more clear. Table 6 shows the optimal number of opponents to face for each hand and how that number varies from Pay Table #1 to Pay Table #2:

TABLE 6

| | PT #1 Optimal | PT #2 Optimal |
|---|---|---|
| Hand | Opponent Number | Opponent Number |
| AA | 5 | 5 |
| KK | 5 | 5 |
| QQ | 5 | 5 |
| JJ | 4 | 5 |
| TT | 4 | 5 |
| 99 | 4 | 5 |
| 88 | 4 | 5 |
| 77 | 3 | 5 |
| 66 | 4 | 2 |
| 55 | 3 | 2 |
| 44 | 1 | 2 |
| 33 | 1 | 2 |
| 22 | 1 | 5 |

When the pay table varies based on the number of opponents faced, preferably the gaming machine 100 displays the variations in the pay table on the display 105 at the time the player is selecting the number of opponents he wishes to face.

In addition to the standard payouts shown on either Pay Table #1 or #2, the present invention may offer a payout for what is commonly known as a “Bad Beat.” Bad Beat jackpots have been offered to poker players in live card rooms for sometime. Typically these jackpots are progressive in nature and are awarded to a player that loses with very powerful poker hand (for instance Four of a Kind or a Straight Flush). In some situations, a percentage of the progressive amount is also awarded to the player that had the better hand and another percentage may be awarded to the other players at the table or in the card room. (For instance, a Bad Beat may award the player with the losing hand 50% of the jackpot, the player with the winning hand 30% of the jackpot, the other players at the table may split 10% of the jackpot and the other players in the card room at different tables may split the remaining 10% of the jackpot.) In games like Hold 'Em where the players all use common community cards, there may also be requirements that one or both of the player's starting cards must play. Because the player of the present invention is playing against one or more opponents, it would be quite simple to add a Bad Beat jackpot to a game employing the present invention. Preferably, this jackpot would be a progressive amount that increases as the play on the gaming device 100 accumulates and multiple gaming devices 100 could be linked in a manner well known in the art to provide for even larger and faster growing jackpots. Like the Bad Beats offered in card rooms, the player may either win the entire jackpot when he has a hand of a given rank that is beaten or he may win a portion of the jackpot for either having his hand beaten, beating a powerful hand, having one of his opponents beat another one of his opponents' powerful hands, or—in the case where multiple gaming machines 100 have been linked—being involved in a game when another player on another gaming machine experiences a Bad Beat. It should be appreciated that the initial jackpot amount of the Bad Beat and the rate at which any progressive amount is increased can be adjusted to adjust the total expected payback percentage to the player. The addition of the Bad Beat will also change the optimal strategy involved for any given game and the strategy will likely change as the progressive amount increases. As the Bad Beat increases players will be encouraged to challenge more opponents.

Returning now to the various methods of increasing the average payout for a win as the number of opponents increases, the next group of variations will now be discussed. This group is classified by the commonality of increasing the payout according to the value of the hands made by the player's opponents. For the purposes of illustrating some of the various methods for accomplishing this, the following pay table will be used:

TABLE 7
Pay Table #3

| WINNING HAND | PAY |
|---|---|
| HIGH CARD | 1 |
| PAIR | 2 |
| 2 PAIR | 3 |
| THREE OF KIND | 4 |
| STRAIGHT | 5 |
| FLUSH | 6 |
| FULL HOUSE | 8 |
| FOUR OF KIND | 15 |
| STRAIGHT FLUSH | 25 |
| ROYAL FLUSH | 100 |

In the first sub-variation, the payout received by the player is determined not by the value of the player's hand, but rather by the value of the hands of his opponents. The exact amount of the payout can be calculated in a variety of ways. One method would be to award the value of the best opponent's hand. Still another method would be to award the sum of all opponents' hands. And yet another method would be to award the product of the values of the opponents' hands. For example, assume that a player faces three opponents and beats each of the opponents by making a Full House. Opponent number one made a Pair, opponent number two made a High Card and opponent number three made a Straight. The values associated with each opponents' hand, per Pay Table #3, would thus be 2 for the Pair, 1 for the High Card and 5 for the Straight. Based on the first method of this sub-variation, the highest ranking opponent's hand is a Straight with a pay of 5. Thus, the player would receive five credits for every credit wagered. Based on the second method, the player would receive the sum of the values of the opponent's hands (2+1+5=8) or eight credits for every credit wagered. Based on the third method, the player would receive the product of the values of the opponents' hands (2×1×5=10) or ten credits for every credit wagered. Notice that the player's payout is independent of the value of his hand. He would receive the same payout whether he won with a higher Straight than opponent number three, a Full House or a Royal Flush. However, as the number of opponents faced increases, the top value, sum and products (provided no hands have a zero value) of the values of their hands will also necessarily increase on average. Thus, it is to the player's advantage to play against the largest number of opponents that he can beat.

Because players of games, and in particular poker, like to be directly rewarded for their own achievements the second sub-variation makes a payout to the player based not only on the value of the opponents' losing hands, but also on the value of the player's winning hand. Again a number of different methods can be used to calculate the exact amount of the payout. Using the same hypothetical player that faces three opponents and beats each of the opponents by making a Full House where opponent number one made a Pair, opponent number two made a High Card and opponent number three made a Straight several of the possible methods will be calculated. The values associated with each opponents' hand, per Pay Table #3, would thus be 2 for the Pair, 1 for the High Card and 5 for the Straight and the player's Full House hand would have a value of 8. Where the player is awarded the sum of his hand and the highest ranked opponent's hand, he would receive thirteen credits for every credit wagered (8+5=13). Where the player is awarded the product of his hand and the highest ranked opponent's hand, he would receive forty credits for every credit wagered (8×5=40). Where the player is awarded the sum of his hand and all of his opponent's hand's values he would receive sixteen credits for every credit wagered (8+1+2+5=16). Where the player is awarded the product of his hand and all of his opponent's hand's values he would receive eighty credits for every credit wagered (8×1×2×5=80).

The last group of variations for increasing payout amounts to be discussed is classified by applying a multiplication factor based on the number of opponents. This multiplication factor may be applied to all or a portion of a pay table. For instance, again using Pay Table #3 as an example, if three opponents are chosen, all the payouts may be tripled. Or, where n represents the number of opponents, only the first nth payouts may be multiplied by (n−1) or any other suitable formulae. In this scheme, when three opponents are selected the payouts for High Card, Pair and Two Pair would be doubled, while the remaining payouts would remain unchanged. Alternatively, the total payout may be calculated by adding the pay table value to another, preferably constant value, that is multiplied by a function of the number of opponents.

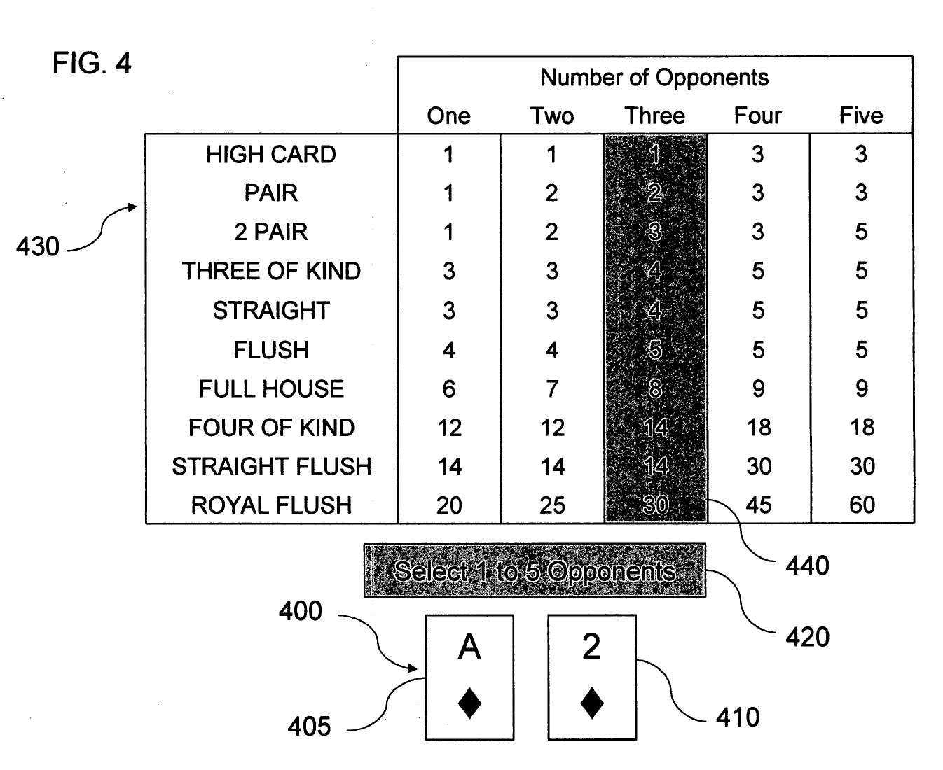

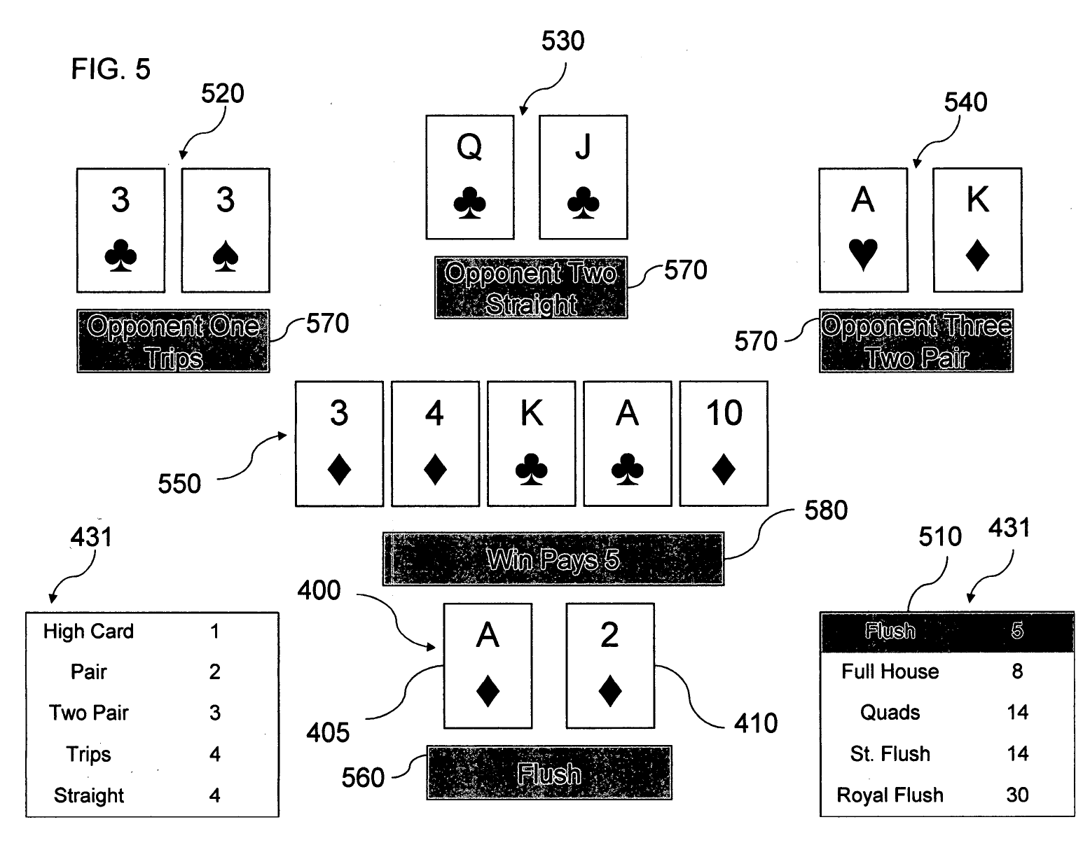

Referring now to FIGS. 4 and 5, possible screen layouts that may be seen on the display device 105 of a gaming machine 100 employing the present invention will now be described. Once more for the purposes of illustration, the specific type of poker game that is being played in this example is Hold 'Em. The pay table varies according to the number of opponents and the payout amount is calculated solely by the rank of the player's winning hands. The player has been dealt an initial starting hand 400 face up. The initial starting hand 400 is an Ace of Diamonds 405 and a Two of Diamonds 410. The display device 105 prompts the player to select a number of active opponents between one and five by displaying a prompt message 420. Also displayed is a pay table 430 that shows the varying payouts for winning hands as a function of the number of opponents. The player may select the number of opponents by using the opponent selection buttons 171, 172, 173, 174 and 175 or, using the touch screen 260, the player may touch the portion of the pay table 430 that contains the desired number of opponents. In this example, the player has selected three opponents, as is indicated by a highlighted visual cue 440.

Referring now to FIG. 5, the outcome of the player's game is displayed. Because the player has selected three opponents, only a relative portion 431 of the pay table 430 is displayed. Each of the three opponent's starting hands, 520, 530 and 540 are revealed to the player. Then a group of five community cards 550 that each opponent and the player will use to make their final hand is displayed. Once each hand is completed, the processor 200 evaluates each hand and may supply a visual prompt 560 under the player's hand to indicate the rank of the player's hand. Visual prompts for the opponents' hands 570 may also be provided. If the player's hand is a winning hand, a highlighted visual cue 510 may be provided on the relative portion of the pay table 431 to alert the player to the amount of any winnings. A win message 580 may also be provided.

Referring now to FIG. 5A, an alternative version of the present invention will now be described. The version represented in FIG. 5A differs from the version in FIG. 5 in that the amount of the payout is calculated by the sum of the values for not only the player's hand but the hand of each opponent. Therefore, the pay table 435 may remain constant regardless of the number of opponents faced and the relative portion of the pay table 431 used in FIG. 5 is not used. Again the starting hands of the player 400 and each opponent 520, 530 and 540 are displayed and once the hands have been completed by dealing the community cards 550, the processor 200 evaluates each hand. A message prompt 561 is displayed under the player's hand informing the player of his final hand's rank and value according to the pay table 435. A highlighted visual cue 510 is also provided on the pay table 435. A group of similar message prompts 571, 572 and 573 are also displayed under the starting hands 520, 530 and 540 of each opponent. And a series of visual cues 511 are displayed on the pay table 435 corresponding to the rank of each opponent's hand. The processor 200 calculates the payout amount by adding the value associated with the player's winning hand to the value associated with each losing opponent's hand and communicates this amount to the player by displaying a win message 585. Preferably win message 585 shows any mathematical operations (in this case addition) that were used to calculate the payout amount.

It should be understood that although the preferred embodiments described herein have all related to poker games, the method of the present invention could be applied to other competitive games, such as Black Jack, Pai Gow or even spinning-reel slots.

It should be understood that all of the foregoing variations relating to the selection of a number of active opponents, the determination as to which hands the selected opponents hold and the calculation of the total payout amount for any given hand may be combined in any number of ways and generally may be performed in any order. Other combinations, orders of operation, additions and modifications to the foregoing may also be made without departing from the scope of the present invention. Thus, the foregoing should be considered illustrative rather than limiting the invention, which is defined only by the following claims.

What is claimed is:

1. A method of playing a game of video poker comprising:
(a) accepting a wager from a player;
(b) dealing a starting poker hand to the player;
(c) dealing a starting poker hand to each potential opponent, wherein the number of potential opponents is at least one;
(d) selecting a number of potential opponents as active opponents;
(e) completing the poker hands of the player and the active opponents;
(f) comparing the completed poker hand of the player to the completed poker hand of the active opponents;
(g) awarding the player a payout when the player's hand is greater than the hands of each active opponent.

2. The method of claim 1 wherein the starting hands of the active opponents are revealed after the player selects the number of active opponents.

3. The method of claim 2 wherein the average amount of any payout made for a winning hand increases as the number of active opponents increases.

4. The method of claim 3 wherein the amount of the payout awarded to the player is determined, at least in part, by comparing the player's completed hand and/or one or more of the completed hands held by an active opponent to a pay table that associates a value with each completed hand.

5. The method of claim 4 wherein there is a predetermined maximum number of active opponents.

6. The method of claim 5 wherein the maximum number of active opponents is less than the number of potential opponents.

7. The method of claim 5 further comprising the steps of:
(a) ranking the starting hand of each potential opponent in an order;
(b) once a number of active opponents has been selected, respectively designating the potential opponents with the highest ranked starting hands as active opponents.

8. The method of claim 5 wherein the player sequentially selects active opponents.

9. The method of claim 8 wherein prior to the player finishing the selection of active opponents, the starting hand of at least one active opponent is revealed to the player.

10. The method of claim 9 wherein the step of selecting a number of active opponents further comprises the steps of:
(a) selecting a single potential opponent and designating said opponent as an active opponent;
(b) revealing the starting hand of the said active opponent;
(c) allowing the player an option of either selecting an additional active opponent or proceeding to the completion and comparison of hands;
(d) repeating steps (a) through (c) until the player has either selected the maximum number of active opponents or has opted to complete and compare the hands.

10. The method of claim 5 wherein the payout received by the player is a function of the value associated with one or more of the completed hands held by an opponent.

11. The method of claim 5 wherein the poker game is Hold 'Em.

12. The method of claim 5 wherein the poker game is Five Card Draw.

13. The method of claim 5 wherein the poker game is Seven Card Stud.

14. The method of claim 5 wherein the poker game is Omaha.

15. The method of claim 5 wherein the player receives a jackpot if he has a Bad Beat.

16. The method of claim 15 wherein the jackpot is a progressive.
